(19) United States
(12) Patent Application Publication
(10) Pub. No.: US 2010/0012060 A1
(43) Pub. Date: Jan. 21, 2010

(54) Split Lobe Design of Concentric Camshaft

(75) Inventors: Glenn E. Clever, Washington, MI (US); Roy Glenn Kaywood, Jackson, MI (US); Jack Stringfield, Fairhaven, MI (US)

Correspondence Address: Harness Dickey & Pierce, P.L.C., P.O. Box 828, Bloomfield Hills, MI, 48303, US

(73) Assignee: GM GLOBAL TECHNOLOGY OPERATIONS, INC., DETROIT, MI (US)

(21) Appl. No.: 12/176,705

(22) Filed: Jul. 21, 2008

(51) Int. Cl. F01L 1/047; F16H 53/00

(52) U.S. Cl. 123/90.6; 74/567

(57) ABSTRACT

An engine assembly may include an engine structure and a camshaft supported on the engine structure. The camshaft may include a first shaft, a first lobe member fixed for rotation with the first shaft, a second lobe member fixed for rotation with the first shaft and spaced axially from the first lobe member, and a third lobe member located on the first shaft axially between the first and second lobe members. The third lobe member may include first and second portions coupled to one another to provide for assembly of the third lobe member on the first shaft after the first and second lobe members are fixed to the first shaft.

### FIELD

The present disclosure relates to engine camshaft assemblies, and more specifically to concentric camshaft assemblies.

### BACKGROUND

The statements in this section merely provide background information related to the present disclosure and may not constitute prior art.

Engines typically include a camshaft to actuate intake and exhaust valves. Some camshafts are concentric camshafts that provide for relative rotation between the intake and exhaust lobes. The intake lobes may be fixed to an outer shaft for rotation with the shaft and the exhaust lobes may be rotatably supported on the shaft. Alternatively, the exhaust lobes may be fixed to the outer shaft for rotation with the shaft and the intake lobes may be rotatably supported on the shaft. In either arrangement, the lobes that are rotatably supported on the shaft may use an outer surface of the shaft as a bearing surface.

### SUMMARY

An engine assembly may include an engine structure and a camshaft supported on the engine structure. The camshaft may include a first shaft, a first lobe member fixed for rotation with the first shaft, a second lobe member fixed for rotation with the first shaft and spaced axially from the first lobe member, and a third lobe member located on the first shaft axially between the first and second lobe members. The third lobe member may include first and second portions coupled to one another to provide for assembly of the third lobe member on the first shaft after the first and second lobe members are fixed to the first shaft.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic illustration of an engine assembly according to the present disclosure;

FIG. 2 is a perspective view of the camshaft and cam phaser of FIG. 1;

FIG. 3 is a perspective exploded view of the camshaft of FIG. 1;

FIG. 4 is a perspective exploded view of a lobe member of the camshaft of FIG. 1; and

FIG. 5 is a fragmentary section view of the camshaft of FIG. 1.

### DETAILED DESCRIPTION

The following description is merely exemplary in nature and is not intended to limit the present disclosure, application, or uses. It should be understood that throughout the drawings, corresponding reference numerals indicate like or corresponding parts and features.

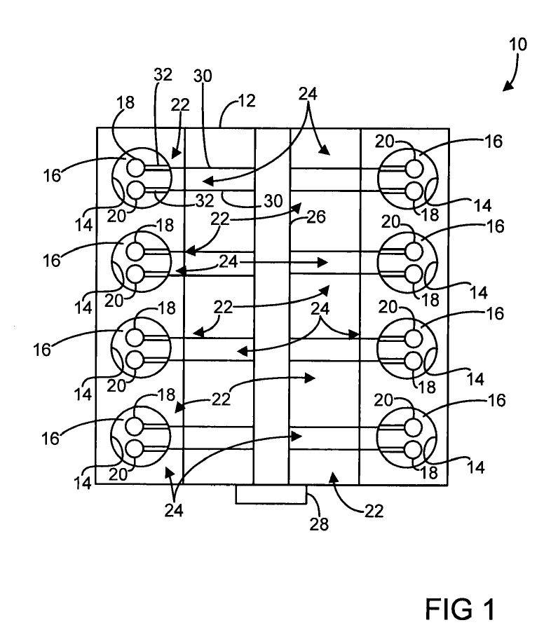

Referring now to FIG. 1, an exemplary engine assembly 10 is schematically illustrated. The engine assembly 10 may include an engine 12 including a plurality of cylinders 14 having pistons 16 disposed therein. The engine 12 may further include an intake valve 18, an exhaust valve 20, and intake and exhaust valve lift mechanisms 22, 24 for each cylinder 14, as well as a camshaft 26 and a cam phaser 28.

The intake valve lift mechanism 22 may include a pushrod 30 and a rocker arm 32. The exhaust valve lift mechanism 24 may additionally include a pushrod 30 and a rocker arm 32. Pushrods 30 may be engaged with the camshaft 26 to actuate the rocker arms 32 and selectively open the intake and exhaust valves 18, 20. While the engine assembly 10 is illustrated as a pushrod engine, it is understood that the present disclosure may be applicable to a variety of other engine configurations as well, such as overhead cam engines.

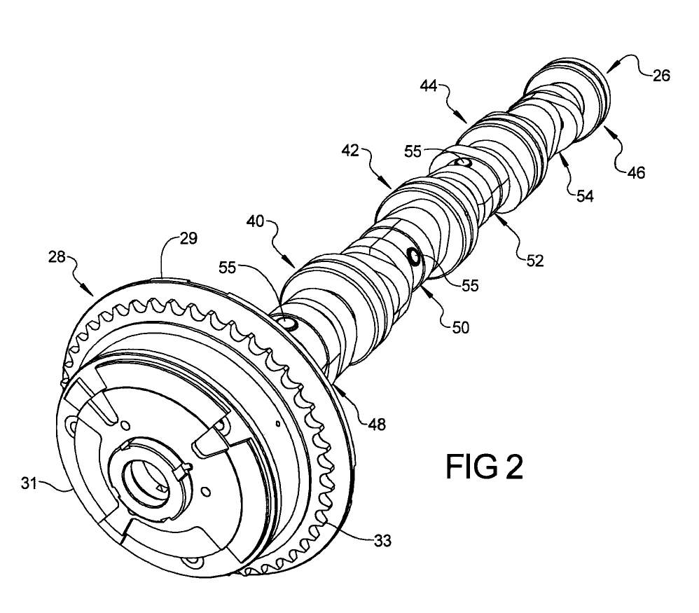

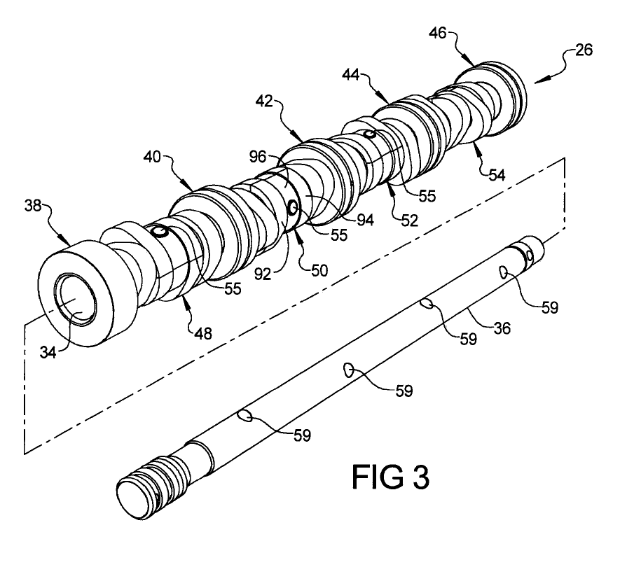

With reference to FIGS. 2, 3, and 5, the camshaft 26 may include first and second shafts 34, 36, a first set of lobe members 38, 40, 42, 44, 46, a second set of lobe members 48, 50, 52, 54, and drive fasteners 55. In the present example, the first set of lobe members 38, 40, 42, 44, 46 may form an intake lobe set and the second set of lobe members 48, 50, 52, 54 may form an exhaust lobe set. However, it is understood that alternate arrangements may be provided where the first set of lobe members 38, 40, 42, 44, 46 may form an exhaust lobe set and the second set of lobe members 48, 50, 52, 54 may form an intake lobe set. The first shaft 34 may be fixed for rotation with a first phaser member 29 and the second shaft 36 may be fixed for rotation with a second phaser member 31. The first and second phaser members 29, 31 may be rotatable relative to one another and relative to a rotationally driven member 33 of the cam phaser 28.

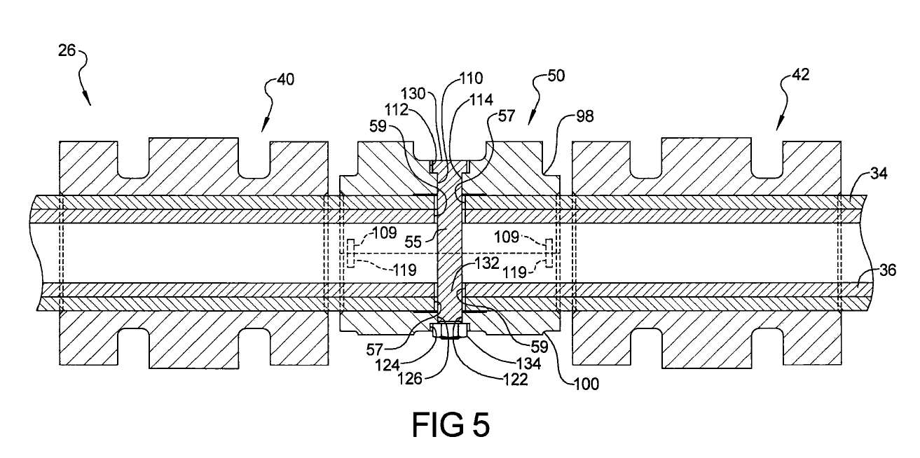

The second shaft 36 may be rotatably disposed within the first shaft 34. The first shaft 34 may include slots 57 (seen in FIG. 5) therethrough and the second shaft 36 may include apertures 59 that receive the fasteners 55 therein and couple the second set of lobe members 48, 50, 52, 54 for rotation with the second shaft 36. The slots 57 in the first shaft 34 may generally allow for a rotational travel of the fasteners 55 therein.

The first set of lobe members 38, 40, 42, 44, 46 may be fixed for rotation with the first shaft 34. The engagement between the first set of lobe members 38, 40, 42, 44, 46 and the first shaft 34 may include a friction fit engagement. The second set of lobe members 48, 50, 52, 54 may be disposed between adjacent ones of the first set of lobe members 38, 40, 42, 44, 46.

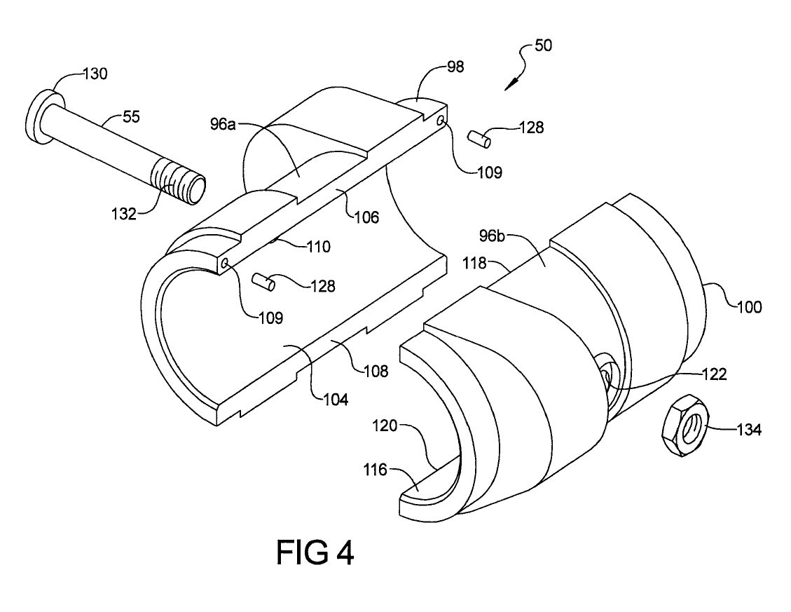

The lobe members 48, 50, 52, 54 may be generally similar to one another. Therefore, the lobe member 50 will be described with the understanding that the description applies equally to the lobe members 48, 52, 54. The lobe member 50 may include first and second lobe portions 92, 94 and a connecting portion 96 extending axially between the first and second lobe portions 92, 94 and fixing the first and second lobe portions 92, 94 to one another. The lobe member 50 may be a multi-piece part. For example, as best seen in FIGS. 4 and 5, the lobe member 50 may include first and second portions 98, 100.

The first and second portions 98, 100 may form first and second halves of the lobe member 50. The first portion 98 may include a bore portion 104 and first and second axial extending surfaces 106, 108 located radially outward from the bore portion 104. The axial extending surface 106 may include recesses 109. An aperture 110 may extend through the connecting portion 96a of the first portion 98 of the lobe member 50 and into the bore portion 104. The aperture 110 may include first and second portions 112, 114. The first portion 112 may form a recess for the fastener 55.

The second portion 100 may include a bore portion 116 and first and second axial extending surfaces 118, 120 located radially outward from the bore portion 116. The axial extending surface 118 may include recesses 119. An aperture 122 may extend through the connecting portion 96b of the second portion 100 of the lobe member 50 and into the bore portion 116. The aperture 122 may include first and second portions 124, 126. The first portion 124 may form a recess for the fastener 55.

The lobe member 50 may be located on the first shaft 34 and may be coupled to the second shaft 36 after the lobe members 40, 42 are fixed to the first shaft 34 by locating the first and second portions 98, 100 of the lobe member 50 on the first shaft 34. The bore portions 104, 106 of the first and second portions 98, 100 of the lobe member 50 may each partially define the complete bore of the lobe member 50. Each of the bore portions 104, 106 may define no more than one hundred and eighty degrees of the circumferential extent of the complete bore. In the example shown, each of the bore portions 104, 106 may define approximately one hundred and eighty degrees of the complete bore.

As seen in FIG. 5, the recesses 109 in the first portion 98 of the lobe member 48 may be aligned with the recesses 119 in the second portion 100. The first axial extending surface 106 of the first portion 98 may overly the first axial extending surface 118 of the second portion 100 and the second axial extending surface 108 of the first portion 98 may overly the second axial extending surface 120 of the second portion 100. More specifically, in the present example, the first axial extending surfaces 106, 118 may abut one another and the second axial extending surfaces 108, 120 may abut one another. Pins 128 may be located in the recesses 109, 119 to orient the first and second portions 98, 100 relative to one another. The fastener 55 may couple the first and second portions 98, 100 of the lobe member 50 to one another and to the first and second shafts 34, 36.

The fastener 55 may include a bolt having a head 130 and a threaded shank 132 and a nut 134. The head 130 may be located within the first portion 112 of the aperture 110. The shank 132 may extend through the slots 57 in the first shaft 34 and the apertures 59 in the second shaft 36 and may be engaged with the nut 134 to fix the first and second portions 98, 100 to one another. The nut 134 may be located in the first portion 124 of the aperture 122.

What is claimed is:

1. A camshaft comprising:
a first shaft;
a first lobe member fixed for rotation with the first shaft;
a second lobe member fixed for rotation with the first shaft and spaced axially from the first lobe member; and
a third lobe member located on the first shaft axially between the first and second lobe members, the third lobe member including first and second portions coupled to one another to provide for assembly of the third lobe member on the first shaft after the first and second lobe members are fixed to the first shaft.

2. The camshaft of claim 1, further comprising a fastening member engaged with the first and second portions of the third lobe member and fixing the first and second portions for rotation with one another.

3. The camshaft of claim 2, further comprising a second shaft rotatably disposed within the first shaft, the third lobe member being rotatable relative to the first shaft and being fixed for rotation with the second shaft.

4. The camshaft of claim 3, wherein the fastening member extends radially through the first and second shafts and fixes the third lobe member for rotation with the second shaft.

5. The camshaft of claim 1, wherein the third lobe member includes a bore receiving the first shaft therein, the first portion defining no more than 180 degrees of a circumferential extent of the bore.

6. The camshaft of claim 5, wherein the second portion defines no more than 180 degrees of the circumferential extent of the bore.

7. The camshaft of claim 1, wherein the third lobe member includes a bore receiving the first shaft therein, the first portion defining a first surface located radially outward from the bore and extending axially along the bore, the second portion defining a second surface located radially outward from the bore, extending axially along the bore, and overlying the first surface.

8. The camshaft of claim 7, wherein the first surface abuts the second surface.

9. The camshaft of claim 7, wherein the third lobe member includes a pin, the first surface including a first recess and the second surface including a second recess, the pin extending within the first and second recesses to locate the first and second portions relative to one another.

10. The camshaft of claim 1, wherein the third lobe member includes a bore receiving the first shaft therein, the first portion of the third lobe member defining approximately 180 degrees of the bore and the second portion defining approximately 180 degrees of the bore.

11. An engine assembly comprising:
an engine structure; and
a camshaft supported on the engine structure and including:
a first shaft;
a first lobe member fixed for rotation with the first shaft;
a second lobe member fixed for rotation with the first shaft and spaced axially from the first lobe member; and
a third lobe member located on the first shaft axially between the first and second lobe members, the third lobe member including first and second portions coupled to one another to provide for assembly of the third lobe member on the first shaft after the first and second lobe members are fixed to the first shaft.

12. The engine assembly of claim 11, further comprising a fastening member engaged with the first and second portions of the third lobe member and fixing the first and second portions for rotation with one another.

13. The engine assembly of claim 12, further comprising a second shaft rotatably disposed within the first shaft and a cam phaser, the third lobe member being supported for rotation on the first shaft and being fixed for rotation with the second shaft, the cam phaser coupled to the camshaft to rotate the second shaft relative to the first shaft.

14. The engine assembly of claim 13, wherein the fastening member extends radially through the first and second shafts and fixes the third lobe member for rotation with the second shaft.

15. The engine assembly of claim 11, wherein the third lobe member includes a bore receiving the first shaft therein, the first portion defining no more than 180 degrees of a circumferential extent of the bore.

16. The engine assembly of claim 15, wherein the second portion defines no more than 180 degrees of the circumferential extent of the bore.

17. The engine assembly of claim 11, wherein the third lobe member includes a bore receiving the first shaft therein, the first portion defining a first surface located radially outward from the bore and extending axially along the bore, the second portion defining a second surface located radially outward from the bore, extending axially along the bore, and overlying the first surface.

18. The engine assembly of claim 17, wherein the first surface abuts the second surface.

19. The engine assembly of claim 17, wherein the third lobe member includes a pin, the first surface including a first recess and the second surface including a second recess, the pin extending within the first and second recesses to locate the first and second portions relative to one another.

20. The engine assembly of claim 11, wherein the third lobe member includes a bore receiving the first shaft therein, the first portion of the third lobe member defining approximately 180 degrees of the bore and the second portion defining approximately 180 degrees of the bore.
